(19) United States
(12) Patent Application Publication
(10) Pub. No.: US 2015/0315529 A1
(43) Pub. Date: Nov. 5, 2015

(54) LOW-WATER TO WATER-FREE LIQUID CLEANING AGENT

(71) Applicant: Henkel AG & Co. KGaA, Duesseldorf (DE)

(72) Inventors: Konstantin Benda, Mettmann (DE); Thomas Eiting, Duesseldorf (DE); Nina Mussmann, Willich (DE); Brigitte Kempen, Dormagen (DE); Thorsten Bastigkeit, Wuppertal (DE)

(21) Appl. No.: 14/797,686

(22) Filed: Jul. 13, 2015

Related U.S. Application Data
(63) Continuation of application No. PCT/EP2014/050072, filed on Jan. 6, 2014.

(30) Foreign Application Priority Data
Jan. 14, 2013 (DE) 10 2013 200 358.7

(51) Int. Cl. C11D 3/37; C11D 1/72

(52) U.S. Cl. CPC C11D 3/3765; C11D 1/72

(57) ABSTRACT

The invention relates to liquid, low-water to water-free cleaning agents, in particular automatic dishwasher detergents, containing at least one rinse aid surfactant and at least one hydrophobically modified acrylate polymer or copolymer, selected from C₁₀-C₃₀ alkyl modified cross-linked polyacrylates, C₁₀-C₃₀ alkyl modified acrylate/vinyl ester copolymer and mixtures thereof. The invention also relates to the uses of said cleaning agents.

### FIELD OF THE INVENTION

The present invention generally relates to liquid, low-water to water-free cleaning agents, and more particularly relates to automatic dishwasher detergents containing at least one rinse aid surfactant and use thereof.

### BACKGROUND OF THE INVENTION

Cleaning agents for hard surfaces such as dishwasher detergents are available to consumers in a variety of product forms. In addition to the traditional solid agents, flowable and in particular liquid-to-gelatinous cleaning agents have become increasingly important in recent times. The consumer values in particular the rapid solubility and thus the rapid availability of the ingredients in the cleaning water, in particular also in short dishwasher programs and at low temperatures, associated with this.

The importance of concentrated compositions, in which the water content in particular is reduced in comparison with traditional compositions, is increasing. For the consumer, compositions having the lowest possible water content, for example, less than 20% by weight, are therefore particularly desirable.

Furthermore, consumers have become accustomed to convenient dosing of pre-apportioned automatic dishwasher detergents and they have so far been using these products mainly in the form of tablets. To bring a liquid dishwasher detergent that offers the above-mentioned advantages in comparison with solid compositions into a pre-apportioned product form, the use of cold water-soluble films in the form of bags is customary. However, the development of formulas is limited thereby because only a limited amount of water can be incorporated into the product. Exceeding the tolerable amount of water leads to premature dissolving of the water-soluble film bag. To ensure good stability of these water-soluble containers in storage, water contents of less than 20% by weight are also desirable.

Therefore, to ensure adequate flowability of the formulation, organic solvents, in particular polyvalent alcohols, are used instead of water. Advantageous alcohols here have proven in particular to be 1,2-propylene glycol and glycerol as well as mixtures thereof. However, a matrix of such organic solvents has only limited ability to absorb adequate amounts of a rinse aid surfactant, which can have negative effects on the rinsing performance of the product. Alkoxylated nonionic surfactants, in particular fatty alcohol alkoxylates, are among the rinse aid surfactants generally used. For an adequate rinsing performance, at least 0.5% by weight of a rinse aid surfactant is usually needed, depending on the remaining composition; at least 1-2% by weight is usually used.

However, it has now been found that the use of rinse aid surfactants in compositions with low water contents, for example, 20% by weight or less, either leads to an unacceptable thickening of the composition and/or, in the case of using organic solvents, leads to separation, in which the rinse aid surfactant and optionally some of the organic solvents float on the remaining composition, so that the latter undergoes an unacceptable thickening.

It has now surprisingly been found that the use of small amounts of hydrophobically modified acrylate polymers or acrylate/vinyl ester copolymers, which are usually used as thickeners, does not lead to thickening in such systems but instead on the contrary leads to a decline in viscosity and stabilization of the agents. This stabilizing effect is manifested in that there is no longer an uncontrolled increase in viscosity, phase separation and solidification of the agents, even during prolonged storage. Furthermore, such agents still have a good rinsing performance without any change.

Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

Liquid, low-water to water-free cleaning agent containing at least one rinse aid surfactant, characterized in that the cleaning agent also contains at least one hydrophobically modified acrylate polymer or copolymer, selected from C₁₀-C₃₀ alkyl-modified cross-linked polyacrylate, C₁₀-C₃₀ alkyl-modified acrylate/vinyl ester copolymer and mixtures thereof in a concentration in the range of greater than 0.01% to less than 1% by weight, based on the cleaning agent.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

In a first aspect, the present invention relates to a liquid, low-water to water-free cleaning agent which contains at least one rinse aid surfactant, characterized in that the cleaning agent additionally contains at least one hydrophobically modified acrylate polymer or copolymer selected from C₁₀-C₃₀ alkyl modified cross-linked polyacrylate, C₁₀-C₃₀ alkyl modified acrylate/vinyl ester copolymer and mixtures thereof in a concentration in the range of greater than 0.01 to less than 1% by weight, based on the cleaning agent.

The term “low-water” as used herein means that the composition characterized in this way contains 20% by weight water or less. In particular compositions containing 1% to 20% by weight water, 1% to 15% by weight water, 5% to 15% by weight water or 10% to less than 20% by weight water fall under this concept.

“Water-free” as used herein means that a composition contains less than 5% by weight, in particular less than 3% by weight, preferably less than 1% by weight water.

The water content, as defined herein, relates to the water content determined by means of Karl Fischer titration.

“Liquid,” as used herein with respect to the cleaning agent according to the invention, includes all flowable compositions and also includes in particular gels and pasty compositions. The term also includes in particular non-Newtonian fluids, which have a flow limit.

“At least one,” as used herein, means 1 or more, for example, 1, 2, 3, 4, 5 or more.

The polyacrylates and acrylate copolymers used according to the invention are characterized in that they are at least partially C₁₀-C₃₀ alkyl modified cross-linked polyacrylates or at least partially hydrophobically, in particular C₁₀-C₃₀ alkyl, modified acrylate/vinyl ester copolymers. “Partially modified” in this context means that at least a portion, preferably at least 20%, more preferably at least 40%, particularly preferably at least 50% of the monomer units are substituted with at least one C₁₀-C₃₀ alkyl radical each. Therefore such polymers are, for example, acrylate/C₁₀-C₃₀ alkyl acrylate copolymers and/or acrylate/C₁₀-C₃₀ alkyl acrylate/C₁₀-C₃₀ alkyl vinyl ester copolymers.

Such polymers are available commercially as thickeners and emulsifiers. For example, Polygel DR (3V Sigma, Italy) and Pemulen® TR1 (Lubrizol, USA) are suitable, although the invention is not limited to these polymers.

In various embodiments of the invention, the amount of the at least one hydrophobically modified acrylate polymer or copolymer in the cleaning agent is 0.02% to 0.8%, preferably 0.03% to 0.5%, more preferably 0.05% to 0.15%, most preferably 0.1% by weight, based on the cleaning agent.

The cleaning agents according to the invention contain at least one rinse aid surfactant. In various embodiments, the rinse aid surfactant is a nonionic surfactant. Although all nonionic surfactants known to those skilled in the art may be used, low-foaming nonionic surfactants, in particular alkoxylated, especially ethoxylated, low-foaming nonionic surfactants are preferably used. In preferred embodiments, the automatic dishwasher detergents contain nonionic surfactants from the group of alkoxylated alcohols.

In various embodiments, nonionic surfactants having a melting point above room temperature may be used. In such embodiments, nonionic surfactant(s) having a melting point above 20° C., preferably above 25° C., particularly preferably between 25° C. and 60° C. and in particular between 26.6° C. and 43.3° C. are preferred in particular.

Preferred surfactants for use originate from the groups of alkoxylated nonionic surfactants, in particular ethoxylated primary alcohols and mixtures of these surfactants having structurally more complex surfactants, such as polyoxy-propylene/polyoxyethylene/polyoxypropylene ((PO/EO/PO) surfactants). Such (PO/EO/PO) nonionic surfactants are also characterized by good foam control.

Low-foaming nonionic surfactants having alternating ethylene oxide and alkylene oxide units are particularly preferred nonionic surfactants. Of these, surfactants having EO-AO-EO-AO blocks are preferred, wherein one to ten EO and/or AO groups are bound to one another before being followed by a block of the other groups. Nonionic surfactants of the following general formula are preferred:

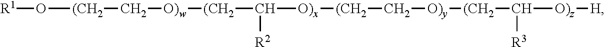

where R¹ stands for a linear or branched, saturated or mono- and/or polyunsaturated C₆-C₂₄ alkyl or alkenyl radical; each R² and/or R³ group, independently of one another, is selected from —CH₃, —CH₂CH₃, —CH₂CH₂—CH₃, CH(CH₃)₂, and indices w, x, y, z independently of one another stand for integers from 1 to 6.

Thus, nonionic surfactants having a C₉-C₁₅ alkyl radical having 1 to 4 ethylene oxide units, followed by 1 to 4 propylene oxide units, followed by 1 to 4 ethylene oxide units, followed by 1 to 4 propylene oxide units are preferred in particular.

Preferred nonionic surfactants here are those of the general formula R¹—CH(OH)CH₂O-(AO)_{w}-(A′O)ₓ-(A″O)_{y}-(A′″O)_{z}—R², in which
R¹ stands for a linear or branched, saturated or monounsaturated and/or polyunsaturated C₆₋₂₄ alkyl or alkenyl radical;
R² stands for H or a linear or branched hydrocarbon radical having 2 to 26 carbon atoms;
A, A′, A″ and A′″, independently of one another, stand for a radical from the group —CH₂CH₂, —CH₂CH₂—CH₂, —CH₂—CH(CH₃), —CH₂—CH₂—CH₂—CH₂, —CH₂—CH(CH₃)—CH₂—, CH₂—CH(CH₂—CH₃),
w, x, y and z stand for values between 0.5 and 120, where x, y and/or z may also be 0.

Due to the addition of the aforementioned nonionic surfactants of the general formula R¹—CH(OH)CH₂O-(AO)_{w}-(A′O)ₓ-(A″O)_{y}-(A′″O)_{z}—R², hereinafter also referred to as “hydroxy mixed ethers,” the cleaning performance of the preparations according to the invention can be improved substantially, namely both in comparison with a surfactant-free system and in comparison with systems that contain alternative nonionic surfactants from the group of polyalkoxylated fatty alcohols, for example.

In particular those end-group-capped poly(oxyalkylated) nonionic surfactants which also have a linear or branched, saturated or unsaturated, aliphatic or aromatic hydrocarbon radical R² having 1 to 30 carbon atoms, where x stands for values between 1 and 90, preferably for values between 30 and 80 and in particular for values between 30 and 60, in addition to a radical R¹, which stands for linear or branched, saturated or unsaturated, aliphatic or aromatic hydrocarbon radicals having 2 to 30 carbon atoms, preferably having 4 to 22 carbon atoms according to the formula R¹O[CH₂CH₂P]ₓCH₂CH(OH)R², are preferred.

Preferred in particular are surfactants of the formula R¹O[CH₂CH(CH₃)O]ₓ—[CH₂CH₂O]_{y}CH₂CH(OH)R², in which R¹ stands for a linear or branched, aliphatic hydrocarbon radical having 4 to 18 carbon atoms or mixtures thereof, R² stands for a linear or branched hydrocarbon radical having 2 to 26 carbon atoms or mixtures thereof, x stands for values between 0.5 and 1.5, and y stands for a value of at least 15. The group of these nonionic surfactants includes, for example, the C₂₋₂₆ fatty alcohol (PO)₁-(EO)₁₅₋₄₀-2-hydroxyalkyl ethers, in particular also the C₈₋₁₀ fatty alcohol (PO)₁-(EO)₂₂-2-hydroxydecyl ethers.

In addition, end-group-capped poly(oxyalkylated) nonionic surfactants of the formula R¹O[CH₂CH₂O]ₓ[CH(R³)O]_{y}CH₂CH(OH)R², in which R¹ and R², independently of one another, stand for a linear or branched, saturated or mono- and/or polyunsaturated hydrocarbon radical having 2 to 26 carbon atoms, R³ is selected independently from —CH₃, —CH₂CH₃, —CH₂CH₂—CH₃, —CH(CH₃)₂, but preferably stands for —CH₃, and x and y, independently of one another, stand for values between 1 and 32, wherein nonionic surfactants having R³═—CH₃ and values for x of 15 to 32 and values for y of 0.5 and 1.5 are most particularly preferred.

Additional nonionic surfactants that are preferred for use are the end-group-capped poly(oxyalkylated) nonionic surfactants of the formula R¹O[CH₂CH(R³)O]ₓ[CH₂]ₖCH(OH)[CH₂]ⱼOR², where R¹ and R² stand for linear or branched, saturated or unsaturated, aliphatic or aromatic hydrocarbon radicals having 1 to 30 carbon atoms, R³ stands for H or a methyl, ethyl, n-propyl, isopropyl, n-butyl, 2-butyl or 2-methyl-2-butyl radical, x stands for values between 1 and 30, k and j stand for values between 1 and 12, preferably between 1 and 5. If the value x is >2, then each R³ in the above formula R¹O[CH₂CH(R³)O]ₓ[CH₂]ₖCH(OH)[CH₂]ⱼOR² may be different. R¹ and R² are preferably linear or branched, saturated or unsaturated, aliphatic or aromatic hydrocarbon radicals with 6 to 22 carbon atoms, but radicals with 8 to 18 carbon atoms are preferred in particular. H, —CH₃ or —CH₂CH₃ are preferred in particular for the radical R³. Particularly preferred values for x are in the range of 1 to 20, in particular 6 to 15.

As described above, each R³ in the above formula may be different if x≧2. The alkylene oxide unit in the brackets can be varied in this way. For example, if x stands for 3, then the R³ radical can be selected to form ethylene oxide units (R³═H) or propylene oxide units (R³═CH₃), which may be linked together in any order, for example, (EO)(PO)(EO), (EO)(EO)(PO), (EO)(EO)(EO), (PO)(EO)(PO), (PO)(PO)(EO) and (PO)(PO)(PO). The value 3 for x has been selected here as an example and may easily be larger, so that the range of variation increases with an increase in values for x and includes, for example, a large number of (EO) groups combined with a small number of (PO) groups or vice versa.

Particularly preferred end-group-capped poly(oxyalkylated) alcohols of the formulas given above have values of k=1 and j=1, so that the above formula is simplified to R¹O[CH₂CH(R³)O]ₓCH₂CH(OH)CH₂OR². In the latter formula, R¹, R² and R³ are as defined above and x stands for numbers from 1 to 30, preferably from 1 to 20 and in particular from 6 to 18. Surfactants in which the R¹ and R² radicals have 9 to 14 carbon atoms, R³ stands for H and x assumes values of 6 to 15 are preferred in particular.

Finally, the nonionic surfactants of the general formula R¹—CH(OH)CH₂O-(AO)_{w}—R², in which the following meanings hold, have proven to be especially effective:
R¹ stands for a linear or branched, saturated or mono- and/or polyunsaturated C₆₋₂₄ alkyl or alkenyl radical;
R² stands for a linear or branched hydrocarbon radical having 2 to 26 carbon atoms;
A stands for a radical from the group CH₂CH₂, CH₂CH₂CH₂, CH₂CH(CH₃), preferably for CH₂CH₂, and
   w stands for values between 1 and 120, preferably 10 to 80, in particular 20 to 40.

The group of these nonionic surfactants includes, for example, the C₄₋₂₂ fatty alcohol (EO)₁₀₋₈₀-2-hydroxyalkyl ethers, in particular also the C₈₋₁₂ fatty alcohol (EO)₂₂-2-hydroxydecyl ethers and the C₄₋₂₂ fatty alcohol (EO)₄₀₋₈₀-2-hydroxyalkyl ethers.

In various embodiments of the invention, instead of the end-group-capped hydroxy mixed ethers defined above, the corresponding non-end-group-capped hydroxy mixed ethers may also be used. These may conform to the above formulas, but in this case, R² is hydrogen and R¹, R³, A, A′, A″, A′″, w, x, and z are as defined above.

The liquid cleaning agents of the invention preferably contain a nonionic surfactant from the group of hydroxy mixed ethers, wherein the amount by weight of the nonionic surfactant of the total weight of the cleaning agent preferably amounts to 0.1 to 3.5, preferably 0.5 to 2.5, more preferably 1.0 to 2.0% by weight.

In various embodiments of the invention, the at least one rinse aid surfactant is a surfactant from the group of polyalkoxylated fatty alcohols, in particular the hydroxy mixed ethers, preferably the end-group-capped hydroxy mixed ethers, and the at least one hydrophobically modified acrylate polymer or copolymer is an alkyl-modified polyacrylate or alkyl-modified acrylate/vinyl ester copolymer, in particular a partially C₁₀-C₃₀ alkyl modified cross-linked polyacrylate or a partially C₁₀-C₃₀ alkyl modified acrylate/vinyl ester copolymer. In such compositions, the amount by weight of the polyalkoxylated fatty alcohol in various embodiments, in particular the hydroxy mixed ethers, preferably the end-group-capped hydroxy mixed ethers, can amount to 0.1% to 3.5%, preferably 0.5% to 2.5%, more preferably 1.0% to 2.0% by weight and the amount by weight of the alkyl-modified polyacrylate or alkyl-modified acrylate/vinyl ester copolymer, in particular a partially C₁₀-C₃₀ alkyl-modified cross-linked polyacrylate or a partially C₁₀-C₃₀ alkyl-modified acrylate/vinyl ester copolymer, amounts to 0.02% to 0.9%, preferably 0.05% to 0.5%, more preferably 0.07% to 0.2%, most preferably 0.1% by weight, each based on the total weight of the cleaning agent.

The cleaning agents according to the invention are preferably a dishwasher detergent, in particular an automatic dishwasher detergent.

In another aspect, the invention relates to such cleaning agents, which may be present in a water-insoluble, water-soluble or water-dispersible packaging, for example, a film containing a single portion.

A further subject matter of the present invention is also an automatic dishwashing method, in which a cleaning agent according to the invention is used.

In yet another aspect, the invention also relates to the use of the cleaning agent according to the invention as a dishwasher detergent, in particular an automatic dishwasher detergent.

Commercially available automatic dishwasher detergents today usually contain phosphates in the form of polyphosphates as a builder component. Polyphosphates that can be used according to the invention include, for example, tripolyphosphates, pyrophosphates and metaphosphates and in particular their sodium or potassium salts. Tripolyphosphates are preferred for use. In various preferred embodiments, the cleaning agent of the invention therefore contains at least one phosphate-containing builder component, preferably a polyphosphate, in particular a tripolyphosphate.

The tripolyphosphates (or triphosphates) that can be used according to the invention are the condensation products of ortho-phosphoric acid (H₃PO₄) with the empirical formula P₃O₁₀⁵⁻ are usually used in the form of their salts, preferably the alkali metal salts or alkaline earth metal salts, more preferably in the form of their alkali metal salts. Tripolyphosphate salts are generally white, odorless, hygroscopic, nonflammable solids that are readily soluble in water. According to the invention, the sodium or potassium salt of tripolyphosphate (Na₅P₃O₁₀ and K₅P₃O₁₀) or a mixture thereof is used in particular.

The amount by weight of the polyphosphates, in particular the tripolyphosphate, of the total weight of the cleaning agent according to the invention is preferably 0.1% to 40% by weight, in particular 1% to 35% by weight, particularly preferably 5% to 32% by weight, more preferably 10% to 30% by weight.

Alternatively or in addition to the phosphates, in particular the polyphosphates, other builder substances, such as, for example, zeolites, silicates, carbonates, may also be used, in particular the alkali carbonates, for example, sodium carbonate, sodium bicarbonate or sodium sesquicarbonate and organic cobuilders.

Silicates that may be considered include in particular crystalline lamellar silicates of the general formula NaMSiₓO₂ₓ₊₁.yH₂O, where M denotes sodium or hydrogen, x is a number from 1.9 to 22, preferably 1.9 to 4, particularly preferred values for x being 2, 3 or 4, and y stands for a number from 0 to 33, preferably from 0 to 20. Amorphous sodium silicates with a modulus of Na₂O:SiO₂ of 1;2 to 1:3.3, preferably of 1:2 to 1:2.8 and in particular of 1:2 to 1:2.6, which are preferably delayed in dissolving and have secondary washing properties, can also be used.

In preferred cleaning agents, the silicate content, based on the total weight of the cleaning agent, is limited to amounts of less than 10% by weight, preferably less than 5% by weight and in particular less than 2% by weight. Particularly preferred cleaning agents are free of silicate.

Organic cobuilders include in particular polycarboxylates/polycarboxylic acids, polymeric polycarboxylates, aspartic acid, polyacetals, dextrins, additional organic cobuilders as well as phosphonates. These substance classes are described below.

Usable organic builder substances include, for example, the polycarboxylic acids that can be used in the form of the free acid and/or their sodium salts, wherein polycarboxylic acids are understood to refer to those carboxylic acids having more than one acid function. For example, these include citric acid, adipic acid, succinic acid, glutaric acid, malic acid, tartaric acid, maleic acid, fumaric acid, sugar acids, nitrilotriacetic acid (NTA), if such use is not objectionable for ecological reasons, as well as mixtures of these. The free acids typically also have the property of an acidification component in addition to their builder effect and thus also serve to adjust a lower and milder pH value of the automatic dishwasher detergent. In particular citric acid, succinic acid, glutaric acid, adipic acid, gluconic acid and any mixtures of these can be mentioned here.

Another important class of builder substances are aminocarboxylic acids and/or the salts thereof. Particularly preferred representatives of this class include methyl glycine diacetic acid (MGDA) or the salts thereof as well as glutamine diacetic acid (GLDA) or the salts thereof or ethylenediamine diacetic acid or the salts thereof (EDDS). Also suitable are iminodisuccinic acid (IDS) and iminodiacetic acid (IDA). Aminocarboxylic acids and their salts may be used together with the aforementioned builder substances, in particular also with the phosphate-free builder substances.

In addition, polymeric polycarboxyl are suitable as builder substances. These include, for example, the alkali metal salts of polyacrylic acid or polymethacrylic acid, for example, those with a relative molecular weight of 500 to 70,000 g/mol.

Suitable polymers include in particular polyacrylates, which preferably have a molecular weight of 2000 to 20,000 g/mol. Because of their superior solubility, the short-chain polyacrylates having molecular weights of 2000 to 10,000 g/mol and particularly preferably of 3000 to 5000 g/mol may in turn be preferred from this group.

Also suitable are polycarboxylate, in particular those of acrylic acid with methacrylic acid and acrylic acid or methacrylic acid with maleic acid. Copolymers of acrylic acid with maleic acid containing 50% to 90% by weight acrylic acid and 50% to 10% by weight maleic acid have proven to be particularly suitable. Their relative molecular weights, based on free acids, generally amounts to 2000 to 70,000 g/mol, preferably 20,000 to 50,000 g/mol and in particular 30,000 to 40,000 g/mol.

The cleaning agents may in particular also contain phosphonates as builder substances. Preferably a hydroxyalkane and/or aminoalkane phosphonate is used as the phosphonate compound. Of the hydroxyalkane phosphonates, 1-hydroxyethane-1,1-diphosphonate (HEDP) is especially important. Ethylenediamine tetramethylene phosphonate (EDTMP), diethylene triamine pentamethylene phosphonate (DTPMP) and their higher homologs are preferably considered as the aminoalkane phosphonates. Phosphonates are preferably contained in the agents in amounts of 0.1% to 10% by weight, in particular in amounts of 0.5% to 8% by weight, each based on the total weight of the cleaning agent.

If the cleaning agents according to the invention contain phosphates, in particular tripolyphosphates, it is preferable for them to contain one or more builder substance(s) (builder/cobuilder) as an additional component in addition to the phosphate-containing builder component. The amount by weight of these additional builder substances that are different from the phosphate-containing builder component in the total weight of the agents according to the invention is preferably 0.1% to 10% by weight and in particular 2% to 7% by weight. These building substances, which are different from the phosphate-containing builder component, include in particular the ones described above as additional builder substances, preferably carbonates, citrates, phosphonates, MGDA, GLDA, iminodisuccinic acid, iminodiacetic acid, EDDS (ethylenediamine-N,N′-disuccinic acid) or the salts of the aforementioned acids, other organic cobuilders and silicates.

Particularly preferred phosphate-containing cleaning agents contain citrate, for example, sodium or potassium citrate, as one of their essential builder substances that are different from the phosphate-containing builder component. Cleaning agents containing 1% to 10% by weight, preferably 2% to 5% by weight, citrate are preferred according to the invention. Additionally or alternatively, particularly preferred phosphate-containing cleaning agents may contain phosphonates, for example, HEDP, as one of the builder substances that are different from the phosphonate-containing builder component. Cleaning agents containing 1% to 10% by weight, preferably 2% to 5% by weight, phosphonate, in particular HEDP, are preferred according to the invention.

The cleaning agents according to the invention may also contain a sulfo polymer. The amount by weight of the sulfo polymer in the total weight of the cleaning agent according to the invention is preferably 0.1% to 20% by weight, in particular 0.5% to 18% by weight, particularly preferably 1.0% to 15% by weight, in particular 4% to 14% by weight, especially 6% to 12% by weight. The sulfo polymer is usually used in the form of an aqueous solution, wherein the aqueous solutions typically contain 20% to 70% by weight, in particular 30% to 50% by weight, preferably approx. 35% to 40% by weight, sulfo polymer(s).

The sulfo polymer used is preferably a polysulfonate copolymer, preferably a hydrophobically modified polysulfonate copolymer.

The copolymers may have two, three, four or more different monomer units.

Preferred polysulfonate copolymers contain at least one monomer from the group of unsaturated carboxylic acids in addition to sulfonic acid group-containing monomer(s).

As unsaturated carboxylic acid(s), unsaturated carboxylic acids of the formula R¹(R²)C═C(R³)COOH, in which R¹ to R³ independently of one another stand for —H, —CH₃, a linear or branched saturated alkyl radical having 2 to 12 carbon atoms, a linear or branched, mono- or polyunsaturated alkenyl radical having 2 to 12 carbon atoms, —NH₂, —OH or —COOH-substituted alkyl or alkenyl radicals as defined above, or standing for —COOH or —COOR⁴, where R⁴ is a saturated or unsaturated, linear or branched hydrocarbon radical having 1 to 12 carbon atoms is/are particularly preferably used.

Particularly preferred unsaturated carboxylic acids include acrylic acid, methacrylic acid, ethacrylic acid, α-chloroacrylic acid, α-cyanoacrylic acid, crotonic acid, α-phenylacrylic acid, maleic acid, maleic anhydride, fumaric acid, itaconic acid, citraconic acid, methylene malonic acid, sorbic acid, cinnamic acid or mixtures thereof. The unsaturated dicarboxylic acids may of course also be used.

Preferred sulfonic acid group-containing monomers are those of the formula

R⁵(R⁶)C═C(R⁷)—X—SO₃H,

where R⁵ to R⁷, independently of one another, stand for —H, —CH₃, a linear or branched, saturated alkyl radical having 2 to 12 carbon atoms, a linear or branched mono- or polyunsaturated alkenyl radical having 2 to 12 carbon atoms, —NH₂, —OH or —COOH— substituted alkyl or alkenyl radicals or —COOH or —COOR⁴, where R⁴ is a saturated or unsaturated linear or branched hydrocarbon radical having 1 to 12 carbon atoms, X stands for a spacer group, which is optionally present and is selected from —(CH₂)₁₁—, where n=0 to 4, —COO—(CH₂)ₖ—, where k=1 to 6, —C(O)—NH—C(CH₃)₂—, —C(O)—NH—C(CH₃)₂—CH₂— and —C(O)—NH—CH(CH₃)—CH₂—.

Of these, the preferred monomers are those of the formulas

H₂C═CH—X—SO₃H

H₂C═C(CH₃)—X—SO₃H

HO₃S—X—(R⁶)C═C(R⁷)—X—SO₃H,

where R₆ and R₇, independently of one another, are selected from —H, —CH₃, —CH₂CH₃, —CH₂CH₂CH₃ and —CH(CH₃)₂, and X stands for a spacer group that is optionally present and is selected from —(CH₂)ₙ—, where n=0 to 4, —COO—(CH₂)ₖ—, where k=1 to 6, —C(O)—NH—C(CH₃)₂—, —C(O)—NH—C(CH₃)₂—CH₂— and —C(O)—NH—CH(CH₃)—CH₂—.

Particularly preferred sulfonic acid group-containing monomers here include 1-acrylamido-1-propanesulfonic acid, 2-acrylamido-2-propanesulfonic acid, 2-acryl-amido-2-methyl-1-propanesulfonic acid, 2-methacrylamido-2-methyl-1-propane sulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxyl)propanesulfonic acid, 2-methyl-2-propene-1-sulfonic acid, styrene sulfonic acid, vinyl sulfonic acid, 3-sulfopropyl acrylate, 3-sulfopropyl methacrylate, sulfomethacrylamide, sulfomethyl methacrylamide as well as mixtures of the aforementioned acids or their water-soluble salts.

The sulfonic acid groups in the polymers may be present entirely or partially in neutralized form, i.e., in some or all of the sulfonic acid groups, the acidic hydrogen atom in the sulfonic acid group may be replaced by metal ions, preferably alkali metal ions and in particular sodium ions. The use of partially or fully neutralized copolymers containing sulfonic acid groups is preferred according to the invention.

The monomer distribution in the copolymers preferred for use according to the invention is preferably 5% to 95% by weight in copolymers containing only carboxylic acid group-containing monomers and sulfonic acid group-containing monomers, particularly preferably the amount of the sulfonic acid group-containing monomer is 50% to 90% by weight and the amount of the carboxylic acid group-containing monomer is 10% to 50% by weight and the monomers here are preferably selected from those listed above.

The molecular weight of the sulfo copolymers preferred for use according to the invention may be varied to adjust the properties of the polymer to the desired intended purpose. Preferred cleaning agents are characterized in that the copolymers have molecular weights of 2000 to 200,000 gmol⁻¹, preferably 4000 to 25,000 gmol⁻¹ and in particular 5000 to 15,000 gmol⁻¹.

In another preferred embodiment, the copolymers also comprise at least one nonionic, preferably hydrophobic, monomer, in addition to the carboxyl group-containing monomer and the sulfonic acid group-containing monomer. The rinsing performance of automatic dishwasher detergents according to the invention has been improved in particular by using these hydrophobically modified polymers.

Anionic copolymers comprising carboxylic acid group-containing monomers, sulfonic acid group-containing monomers and nonionic monomers, in particular hydrophobic monomers, are therefore preferred according to the invention.

Monomers of the general formula R¹(R²)C═C(R³)—X—R⁴, in which R¹ to R³, independently of one another, stand for —H, —CH₃ or —C₂H₅, X stands for a spacer group that is optionally present and is selected from —CH₂—, —C(O)O— and —C(O)—NH—, and R⁴ stands for a linear or branched, saturated alkyl radical having 2 to 22 carbon atoms or for a unsaturated, preferably aromatic radical having 6 to 22 carbon atoms are preferably used as the nonionic monomers.

Particularly preferred nonionic monomers include butene, isobutene, pentene, 3-methylbutene, 2-methylbutene, cyclopentene, hexene, 1-hexene, 2-methyl-1-pentene, 3-methyl-1-pentene, cyclohexene, methyl cyclopentene, cycloheptene, methyl cyclohexene, 2,4,4-trimethyl-1-pentene, 2,4,4-trimethyl-2-pentene, 2,3-dimethyl-1-hexene, 2,4-dimethyl-1-hexene, 2,5-dimethyl-1-hexene, 3,5-dimethyl-1-hexene, 4,4-dimethyl-1-hexane, ethyl cyclohexyne, 1-octene, α-olefins with 10 or more carbon atoms, such as, for example, 1-decene, 1-dodecene, 1-hexadecene, 1-octadecene and C₂₂ α-olefin, 2-styrene, α-methylstyrene, 3-methylstyrene, 4-propylstyrene, 4-cyclohexylstyrene, 4-dodecylstyrene, 2-ethyl-4-benzylstyrene, 1-vinylnaphthalene, 2-vinylnaphthalene, acrylic acid methyl ester, acrylic acid ethyl ester, acrylic acid propyl ester, acrylic acid butyl ester, acrylic acid pentyl ester, acrylic acid hexyl ester, methacrylic acid methyl ester, N-(methyl)acrylamide, acrylic acid 2-ethylhexyl ester, methacrylic acid 2-ethylhexyl ester, N-(2-ethylhexyl)acrylamide, acrylic acid octyl ester, methacrylic acid octyl ester, N-(octyl)acrylamide, acrylic acid lauryl ester, methacrylic acid lauryl ester, N-(lauryl)acrylamide, acrylic acid stearyl ester, methacrylic acid stearyl ester, N-(stearyl)acrylamide, acrylic acid behenyl ester, methacrylic acid behenyl ester and N-(behenyl)acrylamide or mixtures thereof.

Monomer distribution of the hydrophobically modified copolymers preferred for use according to the invention preferably amounts to 5% to 80% by weight, with respect to the sulfonic acid group-containing monomer, the hydrophobic monomer and the carboxylic acid group-containing monomer; the amount of the sulfonic acid group-containing monomer and of the hydrophobic monomer is particularly preferably 5% to 30% by weight each, and the amount of the carboxylic acid group-containing monomer is preferably 60% to 80% by weight, and the monomers here are preferably selected from those listed above.

To supplement the builder substances listed above, which are different from the phosphate-containing builder component, the cleaning agents may contain alkali metal hydroxides. These alkali carriers are preferably used only in small amounts in the cleaning agents, preferably in amounts of less than 10% by weight, preferably less than 6% by weight, preferably less than 5% by weight, particularly preferably between 0.1% and 5% by weight and in particular between 0.5% and 5% by weight, each based on the total weight of the cleaning agent. Alternative cleaning agents according to the invention are free of alkali metal hydroxides.

The cleaning agents according to the invention may contain at least one polyvalent alcohol. Such polyvalent alcohols can make it possible to incorporate other ingredients into a cleaning agent formulation when the amount of water is low, in particular when the amount of water is limited to 20% by weight.

The amount of polyvalent alcohol used in the detergents or cleaning agents produced according to the invention is preferably about at least 20% by weight, in particular about at least 25% by weight, particularly preferably about at least 28% by weight, in particular about at least 30% by weight. Preferred quantity ranges here are from 20% to 50% by weight, in particular 25% to 45% by weight, especially 28% to 40% by weight.

The polyvalent alcohol is preferably selected from glycerol, ethylene glycol, 1,2-propylene glycol, 1,3-propylene glycol, 2-methyl-1,3-propanediol and mixtures thereof.

In a preferred embodiment, a mixture of at least two divalent alcohols is used.

A polyvalent alcohol that is particularly preferred for use according to the invention is 1,2-propylene glycol. 1,2-Propylene glycol is preferably used in an amount of 1% to 40% by weight, in particular in an amount of 2% to 35% by weight, particularly preferably in an amount of 5% to 30% by weight, in the agents according to the invention.

Another polyvalent alcohol that is particularly preferred for use according to the invention is glycerol. Glycerol is preferably used in agents according to the invention in an amount of 1% to 40% by weight, in particular in an amount of 2% to 35% by weight, particularly preferably in an amount of 5% to 30% by weight.

In one particularly preferred embodiment, a mixture of glycerol and 1,2-propylene glycol is used.

The glycerol is preferably used here in an amount of 0.1% to 40% by weight, in particular in an amount of 2% to 30% by weight, particularly preferably in an amount of 5% to 20% by weight. The 1,2-propylene glycol is preferably used here in an amount of 1% to 40% by weight, in particular in an amount of 5 to 35% by weight, particularly preferably in an amount of 10% to 30% by weight, each based on the total weight of the cleaning agent, wherein the total amount of glycerol and 1,2-propylene glycol is preferably at least 20% by weight, in particular at least 25% by weight, especially at least 30% by weight, particularly preferably 25% to 45% by weight, in particular 30 to 42% by weight, especially 35 to 40% by weight. The weight ratios of glycerol:1,2-propylene glycol may be in the range of 1:7 to 7:1, preferably in the range of 3:1 to 1:6. Depending on the other ingredients, it may be preferable for the alcohol mixture to contain more glycerol than 1,2-propylene glycol. In such a case, the glycerol:1,2-propylene glycol ratio may be in the range of 1:1 to 3:1 and/or the glycerol concentration may be in the range of 20% to 30% by weight and the 1,2-propylene glycol concentration is in the range of 5% to 20% by weight. Alternatively, the ratio may be reversed and the cleaning agent may contain larger amount of propylene glycol. In such embodiments, the glycerol:1,2-propylene glycol ratio is approx. 1:7 to 1:3 and/or the glycerol concentration is in the range of 2% to 10% by weight and the 1,2-propylene glycol concentration is in the range of 25% to 35% by weight.

In general, the pH value of the cleaning agent can be adjusted by means of the usual pH regulators, wherein the pH value is selected depending on the desired intended purpose. In various embodiments, the pH value is in a range of 5.5 to 10.5, preferably 5.5 to 9.5, more preferably 7 to 9, in particular greater than 7, especially in the range of 7.5 to 8.5. Acids and/or alkalis, preferably alkalis, are used as pH adjusting agents. Suitable acids include in particular organic acids such as acetic acid, citric acid, glycolic acid, lactic acid, succinic acid, adipic acid, malic acid, tartaric acid and gluconic acid or amidosulfonic acid. In addition, however, the mineral acids hydrochloric acid, sulfuric acid and nitric acid and/or mixtures thereof may also be used. Suitable bases originate from the group of alkali and alkaline earth metal hydroxides and carbonates, in particular the alkali metal hydroxides, of which potassium hydroxide and in particular sodium hydroxide are preferred. However, a volatile alkali, for example, in the form of ammonia and/or alkanolamines, which may contain up to 9 carbon atoms in the molecule, are particularly preferred. The alkanolamine here is preferably selected from the group consisting of mono-, di-, triethanol and propanolamine and mixtures thereof. The alkanolamine is preferably contained in the agents according to the invention in an amount of 0.5% to 10% by weight, in particular in an amount of 1% to 6% by weight.

To adjust and/or stabilize the pH value, the agent according to the invention may contain one or more buffer substance(s) (INCI buffering agents), usually in amounts of 0.001% to 5% by weight. Buffer substances which are complexing agents or even chelating agents (chelators, INCI chelating agents) at the same time are preferred. Particularly preferred buffer substances include citric acid and/or citrates, in particular sodium and potassium citrates, for example, trisodium citrate.2H₂O and tripotassium citrate.H₂O.

The agents according to the invention preferably contain at least one additional ingredient, preferably selected from the group consisting of anionic, cationic and amphoteric surfactants, bleaching agents, bleach activators, bleach catalysts, enzymes, thickeners, sequestering agents, electrolytes, corrosion inhibitors, in particular silver protectants, glass corrosion inhibitors, foam inhibitors, dyes, fragrances, bitter substances and antimicrobial active ingredients.

Preferred anionic surfactants include fatty alcohol sulfates, fatty alcohol ether sulfates, dialkyl ether sulfates, monoglyceride sulfates, alkylbenzene sulfonates, olefin sulfonates, alkane sulfonates, ether sulfonates, n-alkyl ether sulfonates, ester sulfonates and lignin sulfonates. Also usable within the scope of the present invention are fatty acid cyanamides, sulfosuccinates (sulfosuccinic acid esters), in particular sulfosuccinic acid mono- and di-C₈-C₁₈ alkyl esters, sulfosuccinamates, sulfosuccinamides, fatty acid isethionates, acylaminoalkane sulfonates (fatty acid taurides), fatty acid sarcosinates, ether carboxylic acids and alkyl (ether) phosphates as well as α-sulfo fatty acid salts, acyl glutamates, monoglyceride disulfates and alkyl ethers of glycerol disulfate.

The anionic surfactants are preferably used as sodium salts but may also be present as other alkali or alkaline earth metal salts, for example, potassium or magnesium salts as well as in the form of ammonium or mono-, di-, tri- and/or tetraalkylammonium salts, also in the form of their corresponding acid in the case of sulfonates, e.g., dodecylbenzene sulfonic acid.

Suitable amphoteric surfactants include, for example, betaines of the formula (Rⁱⁱⁱ)(R^{iv})(R^{v})N⁺CH₂COO⁻, in which Rⁱⁱⁱ denotes an alkyl radical having 8 to 25 carbon atoms, preferably 10 to 21 carbon atoms, optionally interrupted by hetero atoms or heteroatom groups, and R^{iv} and R^{v} denote similar or different alkyl radicals having 1 to 3 carbon atoms, in particular C₁₀-C₁₈ alkyldimethylcarboxymethylbetaine and C₁₁-C₁₇ alkylamidopropyldimethylcarboxymethylbetaine.

Suitable cationic surfactants include among others the quaternary ammonium compounds of formula (R^{vi})(R^{vii})(R^{viii})(R^{ix})N⁺X⁻, in which R^{vi} to R^{ix} stand for four similar or different alkyl radicals, in particular two long chain and two short chain alkyl radicals, and X⁻ stands for an anion, in particular a halide ion, for example, didecyldimethylammonium chloride, alkylbenzyldidecylammonium chloride and mixtures thereof. Other suitable cationic surfactants include the quaternary surface-active compounds, in particular those with a sulfonium, phosphonium, iodonium or arsonium group which are also known as antimicrobial active ingredients. By using quaternary surface-active compounds having an antimicrobial effect, the agent may be embodied with an antimicrobial effect and/or its antimicrobial effect that is already present, optionally based on other ingredients, may be improved.

The enzymes include in particular proteases, amylases, lipases, hemicellulases, cellulases, perhydrolases or oxidoreductases as well as preferably mixtures thereof. These enzymes are in principle of natural origin. Starting from the natural molecules, improved variants are available for use in cleaning agents and are preferred for use accordingly. Cleaning agents according to the invention contain enzymes preferably in total amounts of 1×10⁻⁶ to 5% by weight, based on active protein. The protein concentration can be determined with the help of known methods, for example, the BCA method or the biuret method.

Of the proteases, those of the subtilisin type are preferred. Examples of these include the subtilisins BPN′ and Carlsberg as well as their more developed forms, the protease PB92, the subtilisin 147 and 309, the alkaline protease from Bacillus lentus, subtilisin DY and the enzymes thermitase, proteinase K and the proteases TW3 and TW7, which are to be assigned to the subtilases and no longer to the subtilisins in the narrower sense.

Examples of amylases that can be used according to the invention include the α-amylases from Bacillus licheniformis, from B. amyloliquefaciens, from B. stearothermophilus, from Aspergillus niger and A. oryzae as well as the further developments of the aforementioned amylases that have been improved for use in cleaning agents. In addition, the α-amylase from Bacillus sp. A 7-7 (DSM 12368) and the cyclodextrin glucanotransferase (CGTase) from B. agaradherens (DSM 9948) should also be emphasized for this purpose.

In addition, lipases or cutinases can also be used according to the invention, in particular because of their triglyceride-cleaving activities but also in order to create per acids from suitable precursors in situ. These include, for example, the lipases obtainable originally from Humicola lanuginosa (Thermomyces lanuginosus) and/or further developed lipases, in particular those with the amino acid exchange D96L.

In addition, enzymes summarized under the heading hemicellulases may also be used. These include, for example, mannanases, xanthan lyases, pectin lyases (=pectinases), pectin esterases, pectate lyases, xyloglucanases (=xylanases), pullulanases and β-glucanases.

To increase the bleaching effect, oxidoreductases, for example, oxidases, oxygenases, catalases, peroxidases like halo-, chloro-, bromo-, lignin, glucose or manganese peroxidases, dioxygenases or laccases (phenol oxidases, polyphenol oxidases) may also be used according to the invention. In addition, preferably organic compounds, particularly preferably aromatic compounds, that interact with the enzymes may advantageously also be added to enhance the activity of the respective oxidoreductases (enhancer) or to ensure the electron flow in the case of extremely different redox potentials between the oxidizing enzymes and the soiling (mediators).

A protein and/or enzyme can be protected, in particular during storage, against damage such as inactivation, denaturing or decomposition, for example, due to physical influences, oxidation or proteolytic cleavage. When the proteins and/or enzymes are produced microbially, inhibition of proteolysis is preferred in particular, in particular when the agents also contain proteases. Cleaning agents may contain stabilizers for this purpose. Providing such agents constitutes a preferred embodiment of the present invention.

Cleaning-active proteases and amylases are not usually supplied in the form of the pure protein but instead in the form of stabilized preparations suitable for being shipped and stored. These prefabricated preparations include, for example, the solid preparations obtained by granulation, extrusion or lyophilization or in particular in the case of liquid or gelatinous agents, solutions of the enzymes, may advantageously be in the most concentrated form possible, having a low water content and/or mixed with stabilizers or additional additives.

Alternatively, the enzymes for both solid and liquid dosage forms may also be encapsulated, for example, by spray drying or extrusion of the enzyme solution together with a preferably natural polymer or in the form of capsules, for example, those in which the enzymes are enclosed in a solidified gel or in such dosage forms of the core-shell type, in which a core containing an enzyme is coated with a protective layer that is impermeable for water, air and/or chemicals. In addition, other active ingredients, for example, stabilizers, emulsifiers, pigments, bleaching agents or dyes, may also be applied in applied layers. Such capsules are applied according to methods that are known per se, for example, by shaking or rolling granulation or in fluid-bed processes. Such granules are advantageously low-dust, for example, due to the application of polymeric film-forming substances, and stable in storage because of the coating.

In addition, it is possible to fabricate two or more enzymes together, so that a single granular product has a plurality of enzyme activities.

As can be seen from the preceding statements, the enzyme protein forms only a fraction of the total weight of the usual enzyme preparations. Protease and amylase preparations that are preferred for use according to the invention contain between 0.1% and 40% by weight, preferably between 0.2% and 30% by weight, particularly preferably between 0.4% and 20% by weight, and in particular between 0.8% and 10% by weight of the enzyme protein.

Cleaning agents that contain, each based on their total weight, 0.1% to 12% by weight, preferably 0.2% to 10% by weight, and in particular 0.5 to 8% by weight enzyme preparations, are preferred in particular.

The glass corrosion inhibitors that are used are preferably zinc salts, in particular zinc acetate. Glass corrosion inhibitors are preferably present in the agents according to the invention in an amount of 0.05 to 5% by weight, in particular in an amount of 0.1% to 2% by weight.

In various embodiments, the cleaning agent immediately after production has a viscosity above 2000 mPas (Brookfield viscometer DV-II+Pro, spindle 25, 30 rpm, 20° C.), in particular between 2000 and 10,000 mPas. After storage the viscosity may be higher, for example, higher than 10,000 mPas, such as in the range of 10,000-50,000 mPas (Brookfield viscometer DV-II+Pro, spindle 25, 5 rpm, 20° C.). It is preferable for the agent to be flowable at room temperature.

The cleaning agent may be contained in a water-insoluble, water-soluble or water-dispersible packaging. The invention therefore also relates to kits containing the cleaning agent together with such packaging. The cleaning agent may be finished in such a way that single portions are packaged separately.

The cleaning agent according to the invention is preferably contained in a water-soluble packaging. The water-soluble packaging allows portioning of the cleaning agent. The amount of cleaning agent in the portion package is preferably 5 to 50 g, particularly preferably 10 to 30 g, in particular 15 to 25 g.

The water-soluble casing is preferably formed from a water-soluble film material which is selected from the group consisting of polymers or polymer mixtures. The casing may be formed from one or two or more layers of the water-soluble film material. The water-soluble film material of the first layer and the additional layers, if present, may be the same or different. Films that can be glued and/or sealed to form packagings, such as tubes or pods, after being filled with an agent, are preferred in particular.

It is preferable for the water-soluble casing to contain polyvinyl alcohol or a polyvinyl alcohol copolymer. Water-soluble casings containing polyvinyl alcohol or a polyvinyl alcohol copolymer have a good stability with a sufficiently high water solubility, in particular a cold water solubility.

Suitable water-soluble films for producing the water-soluble casing are preferably based on a polyvinyl alcohol or a polyvinyl alcohol copolymer whose molecular weight is in the range of 10,000 to 1,000,000 gmol⁻¹, preferably of 20,000 to 500,000 gmol⁻¹, particularly preferably of 30,000 to 100,000 gmol⁻¹ and in particular of 40,000 to 80,000 gmol⁻¹.

Polyvinyl alcohol is usually produced by hydrolysis of polyvinyl acetate because the direct synthesis pathway is impossible. The situation is similar for polyvinyl alcohol copolymers that are produced from polyvinyl acetate copolymers accordingly. It is preferable if at least one layer of the water-soluble casing comprises a polyvinyl alcohol whose degree of hydrolysis amounts to 70 to 100 mol %, preferably 80 to 90 mol %, particularly preferably 81 to 89 mol %, and in particular 82 to 88 mol %.

A polyvinyl alcohol-containing film material suitable for producing the water-soluble casing may additionally contain a polymer selected from the group comprising (meth)acrylic acid-containing (co)polymers, polyacrylamides, oxazoline polymers, polystyrene sulfonates, polyurethanes, polyesters, polyethers, polylactic acid or mixtures of the aforementioned polymers. Polylactic acids are a preferred additional polymer.

Preferred polyvinyl alcohol copolymers comprise, in addition to vinyl alcohol, dicarboxylic acids as additional monomers. Suitable dicarboxylic acids include itaconic acid, malonic acid, succinic acid and mixtures thereof, but itaconic acid is preferred.

Additional preferred polyvinyl alcohol copolymers comprise, in addition to vinyl alcohol, an ethylenically unsaturated carboxylic acid, its salt or its esters. Such polyvinyl alcohol copolymers particularly preferably contain, in addition to vinyl alcohol, acrylic acid, methacrylic acid, acrylic acid esters, methacrylic acid esters or mixtures thereof.

It may be preferable for the film material to contain additional additives. The film material may contain plasticizers, for example, such as dipropylene glycol, ethylene glycol, diethylene glycol, propylene glycol, glycerol, sorbitol, mannitol or mixtures thereof. Additional additives comprise, for example, release aids, fillers, cross-linking agents, surfactants, antioxidants, UV absorbers, antiblocking agents, antisticking agents or mixture thereof

Suitable water-soluble films for use in the water-soluble casings of the water-soluble packagings according to the invention are films distributed by the company MonoSol LLC, for example, under the designation M8630, C8400 or M8900. Other suitable films comprise films with the designation Solublon® PT, Solublon® GA, Solublon® KC or Solublon® KL from Aicello Chemical Europe GmbH or the films VF-HP from Kuraray.

The cleaning agents according to the invention may be used as dishwasher detergents, in particular automatic dishwasher detergents. The corresponding use is also the subject matter of the invention.

The invention also relates to a dishwashing method, in particular an automatic dishwashing method, in which a cleaning agent according to the invention is used.

The cleaning agents according to the invention are characterized in that they are stable in storage and no phase separation occurs even after a long time.

### Exemplary Embodiments

The cleaning agent formulation M1 according to the invention as well as the comparative recipes V1-V4 were prepared. The compositions are shown in the following Table 1, where the quantitative amounts are given in percent by weight active substance. Polygel DR (3V Sigma) was used as the hydrophobically modified acrylate/vinyl ester copolymer.

The rinsing performance of the recipes was tested as follows: various materials (glass, porcelain (black), stainless steel, plastic) were washed four times in a Miele G 698 SC dishwashing machine at 50° C. and 21° dH [German degrees of water hardness], using 20 g of the respective recipe and 100 g fat-based soiling and evaluated visually after each of the second to fourth wash cycles. To do so, the machine was opened completely for 30 minutes after the end of the wash cycle and then determined visually in the black box (evaluation space, matte black painted or lined, sealed light-tight and equipped with artificial lighting using two fluorescent tubes (Philips TLD 36W/965 Natural Daylight 6500)). Table 1 lists the results for the tested recipes:

TABLE 1
Recipes

| | M1 | V1 | V2 | V3 | V4 |
|---|---|---|---|---|---|
| Potassium | 27 | 27 | 27 | 27 | 27 |
| tripolyphosphate | | | | | |
| Sodium tripolyphosphate | 7.5 | 7.5 | 7.5 | 7.5 | 7.5 |
| Sulfo polymer, sodium | 9 | 9 | 9 | 9 | 9 |
| salt | | | | | |
| Sodium citrate dihydrate | 4 | 4 | 4 | 4 | 4 |
| HEDP | 4 | 4 | 4 | 4 | 4 |
| Glycerol | 5 | 5 | 5 | 5 | 5 |
| 1,2-Propylene glycol | 30 | 30 | 30 | 30 | 30 |
| Fatty alcohol alkoxylate | 2 | 2 | 2 | 2 | 2 |
| Acrylic acid polymer, | 1 | 1 | 1 | 1 | 1 |
| sodium salt | | | | | |
| Ethanolamine | 3.5 | 3.5 | 3.5 | 3.5 | 3.5 |
| Enzymes | 4 | 4 | 4 | 4 | 4 |
| Zinc acetate | 0.2 | 0.2 | 0.2 | 0.2 | 0.2 |
| Hydrophobically | 0.1 | − | 1.0 | 0.01 | − |
| modified acrylate/ | | | | | |
| vinyl ester | | | | | |
| copolymer | | | | | |
| Unmodified polyacrylate | − | − | − | − | 0.1 |
| Perfume, dye, additives, | to 100 | to 100 | to 100 | to 100 | to 100 |
| water | | | | | |
| Stability of the recipe | ++ | − | −− | − | − |
| Viscosity after storage | + | ∘ | −− | − | −− |
| Rinsing performance | + | + | n.a. | + | + |

n.a. = not applicable
++ = very good
+ = good
∘ = adequate
− = poor
−− = very poor

The stability of the recipe according to the invention was very good, but the stability in the comparative recipes was poor or very poor, i.e., there was separation and phase separation of the individual components. The viscosity remained constant over a longer period of storage only in the case of the recipe according to the invention but in all the comparative recipes there was an uncontrolled increase in viscosity, i.e., the recipes exhibited thixotropic behavior (o) or solidified (- and --).

On the whole, the results of this study show that the recipe according to the invention is definitely superior to the comparative recipes based on the stability and the change in viscosity in prolonged storage and maintains a good rinsing performance at the same time.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. Liquid, low-water to water-free cleaning agent comprising at least one rinse aid surfactant, wherein the cleaning agent also comprises at least one hydrophobically modified acrylate polymer or copolymer, selected from C₁₀-C₃₀ alkyl-modified cross-linked polyacrylate, C₁₀-C₃₀ alkyl-modified acrylate/vinyl ester copolymer and mixtures thereof in a concentration in the range of greater than 0.01% to less than 1% by weight, based on the cleaning agent.

2. Cleaning agent according to claim 1, wherein the amount of the at least one hydrophobically modified acrylate polymer or copolymer in the cleaning agent is in the range of 0.02% to 0.8%, based on the cleaning agent.

3. Cleaning agent according to claim 1, wherein the amount of the at least one rinse aid surfactant in the cleaning agent is in the range of 0.1% to 3.5%, based on the cleaning agent.

4. Cleaning agent according to claim 1, wherein the at least one rinse aid surfactant is selected from the group of alkoxylated alcohols.

5. Cleaning agent according to claim 1, wherein the cleaning agent also comprises at least one builder or cobuilder.

6. Cleaning agent according to claim 1, wherein the cleaning agent also comprises one or more of the substances selected from the group consisting of complexing agents, pH adjusting agents, anionic, cationic and amphoteric surfactants, bleaching agents, bleach activators, bleach catalysts, enzymes, thickeners, sequestering agents, electrolytes, corrosion inhibitors, in particular silver protectants, glass corrosion inhibitors, foam inhibitors, dyes, fragrances, bitter substances and antimicrobial active ingredients.

7. Cleaning agent according to claim 1, wherein it is in a water-insoluble, water-soluble or water-dispersible packaging, in particular in a film containing polyvinyl alcohol.

8. Automatic dishwashing method, characterized in that a cleaning agent according to claim 1 is contacted with dishware in an automatic dishwasher.
